(19) United States
(12) Patent Application Publication
(10) Pub. No.: US 2025/0269983 A1
(43) Pub. Date: Aug. 28, 2025

(54) PASSIVE LOW-GRAVITY CRYOGENIC BOILER

(71) Applicant: Blue Origin Manufacturing, LLC, Huntsville, AL (US)

(72) Inventors: Gary D. Grayson, Maple Valley, WA (US); Michael Friedman, Belton, TX (US); Victor Barackman, Corona, CA (US); Evan C. Rege, Indialantic, FL (US); Joshua R. Calvert, Littleton, CO (US); James W. Nord, Jupiter, FL (US)

(21) Appl. No.: 18/590,744

(22) Filed: Feb. 28, 2024

(51) Int. Cl. B64G 1/40; F17C 7/02

(52) U.S. Cl. CPC B64G 1/4021; F17C 7/02; F17C 2221/011; F17C 2223/0161; F17C 2227/0135; F17C 2227/0304; F17C 2270/0194

(57) ABSTRACT

A boiler system and methods of operating the system in a low-gravity environment are disclosed. The boiler system, which converts a cryogenic liquid to its gas phase, may be used in various types of space vehicles for various types of missions. The system principally operates using waste heat that is invariably produced during the many functions and processes that occur during space flight. The waste heat is collected and applied to a boiler tank in the system, where the cryogenic liquid is resultantly heated to a gas, which may be subsequently used or collected in one or more accumulator tanks, for example. Because waste heat is used in this liquid-to-gas conversion process, the boiler system consumes relatively low amounts of energy produced by, or stored in, a space vehicle.

### BACKGROUND

Gaseous reactants, propellants, and utility gases like gaseous oxygen and hydrogen are used for a variety of functions in a space vehicle. Because oxygen and hydrogen are most often stored as cryogenic liquids, a liquid-gas conversion system would be useful. Such conversion systems may operate using a combustion- or pneumatically-driven pump with a burner and a heat exchanger. This type of operation, which could present energy consumption and reliability concerns, may likely consume reactants (e.g., a fuel and an oxidizer) and likely involve parasitic fluid loss from various cryogenic purges and chill-down operations. In addition, operations in low-gravity require special attention to the behavior and dynamics of liquid and gas phases of the cryogenic liquids (e.g., propellants). Thus, demand continues for a reliable liquid-gas conversion system that has relatively low mass, energy efficiency, and simple manufacturability, while being operable in the confines and limited resources involved in space flight or other space missions.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is schematic flow diagram of a boiler system for operating in a low-gravity environment, according to some embodiments.

FIG. 2 is a top view of a surface texture for passive capillary pumping, according to some embodiments.

FIG. 3 is a cross-section view of a portion of a boiler tank and a surface texture for passive capillary pumping, according to some embodiments.

FIG. 4 is a schematic view of a boiler system, according to some embodiments.

FIG. 5 is a schematic view of a boiler system, according to some other embodiments.

FIG. 6 is an open side view of a boiler tank, according to some embodiments.

FIG. 7 is an open side view of a boiler tank for use with oxygen, according to some embodiments.

FIG. 8 is a flow diagram of an example process for operating a boiler system in a low-gravity environment, according to some embodiments.

### DETAILED DESCRIPTION

This disclosure describes systems and methods of operating a boiler system in a low-gravity environment. The boiler system, which converts a cryogenic liquid to its gas phase, may be used in various types of space vehicles (e.g., including lunar stations and planetary stations) for various types of missions. The system may principally operate using waste heat that is invariably produced during the many functions and processes that occur during space flight, for example. The waste heat is collected and applied to a boiler tank in the system, where the cryogenic liquid is resultantly heated to a gas at increased pressure, which may subsequently be used or collected in one or more accumulator tanks, for example. Because waste heat is used in this liquid-to-gas conversion process, the boiler system consumes relatively low amounts of energy produced by, or stored in, a space vehicle. The boiler system may also involve relatively few mechanical parts so that it may be considered more reliable and less massive, as compared to a conversion system that relies on a combustion- or pneumatically driven-pump, burner, and a heat exchanger. For example, the boiler system, in some passive implementations, may operate using only tanks, valves, fluids, and available waste heat from avionics, fuel cells, and an electrical power system.

In some embodiments, the boiler system includes a cryogenic tank that provides a cryogenic liquid, which may be hydrogen or oxygen for example, to a boiler tank. The boiler system further includes a capillary pumping surface on the inside surface of the boiler tank. The capillary pumping surface, described in detail below, is configured to receive a waste heat from outside the boiler tank. The waste heat may be produced by one or more processes in various locations in a space vehicle, as explained below. The boiler tank includes an output port to vent gas produced from boiling the cryogenic liquid in the boiler tank by the received waste heat. The boiler system may further include one or more accumulator tanks that receive the vented gas from the output port. In some implementations, one or more accumulator tanks may be inside the boiler tank, though example embodiments herein describe accumulator tanks being outside of the boiler tank. Claimed subject matter is not limited in this respect.

The boiler system may also include a heat collector to collect the waste heat from various locations of the space vehicle. A heat transfer path may be used to transfer the waste heat from the heat collector to the capillary pumping surface in the boiler tank. At least a portion of the heat transfer path may be a conduit to carry heated fluid or a solid heat conductive material (e.g., a metal strap). The heat collector may be configured to collect waste heat produced by a hydraulic system, fuel cells, and/or a fuel/oxidizer propulsion system of the space vehicle, just to name a few examples. The system may include a thermal switch that controls thermal energy flow in the heat transfer path.

In some implementations, if the cryogenic liquid in the boiler system is liquid oxygen, then the boiler tank may include magnets adjacent to the capillary pumping surface. As explained below, the paramagnetic properties of liquid oxygen provide an opportunity to at least partially control the behavior of its liquid and gas phases.

In some implementations, the boiler tank may include a thermal control loop adjacent and external to the capillary pumping surface. The thermal control loop may be configured to circulate a pumped fluid such as ammonia to transfer heat into and out of the boiler tank.

In some embodiments, waste heat need not be relied upon to operate the boiler system. For example, a heat exchanger may be in the boiler tank to directly heat the contents (e.g., a cryogenic liquid). The heat exchanger may be configured to receive exhaust from a combustion device located elsewhere in the space vehicle. A resistance coil heater may also, or instead, be in the boiler tank. The resistance coil heater may be electrically connected to an electric current source, such as a generator, batteries, or solar panels, just to name a few examples.

In some embodiments, a method of operating a passive boiler system, which may be in a low-gravity environment, includes transferring a cryogenic liquid from a cryogenic tank to a boiler tank. Waste heat produced by at least one part of a space vehicle may be subsequently collected and routed to the boiler tank. Using capillary pumping on an inside surface of the boiler tank, cryogenic liquid may be at least partially retained against the inside surface of the boiler tank so that relatively efficient heat transfer to the cryogenic liquid can occur. The waste heat is provided to boil the at least partially retained cryogenic liquid. Gas produced from the boiling may be vented from the boiler tank and collected into an accumulator tank.

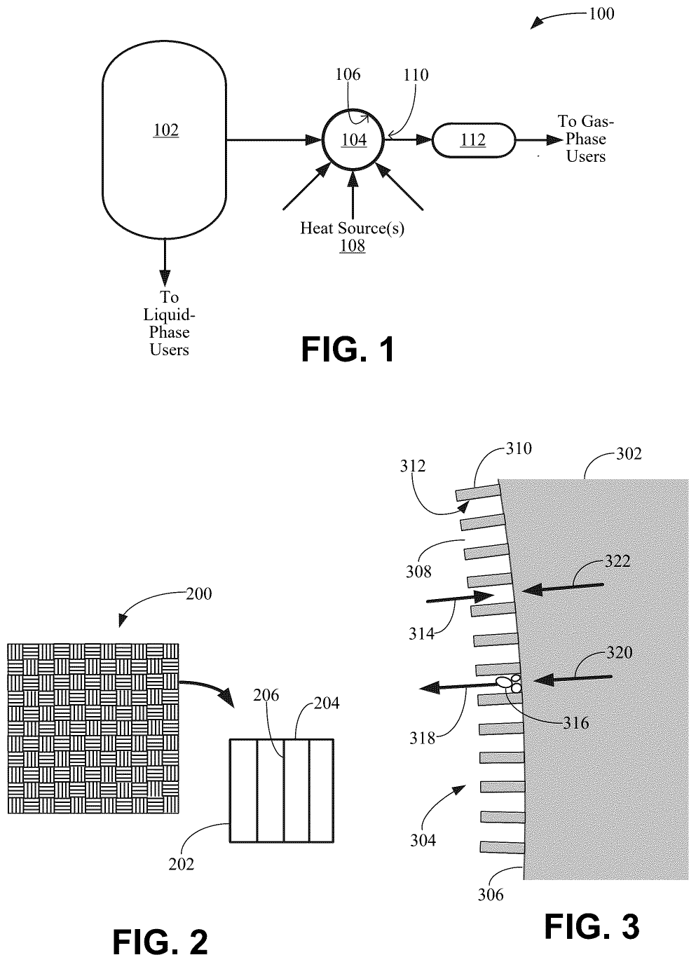

FIG. 1 is schematic flow diagram of a boiler system 100 for operating in a low-gravity environment, such as beyond Earth's gravity, according to some embodiments. Boiler system 100, which may operate in a space vehicle, includes a cryogenic tank 102 that stores a cryogenic liquid, such as liquid oxygen (LO2) or liquid hydrogen (LH2). Cryogenic tank 102 may provide its stored cryogenic liquid to any number of users, including a propulsion system (not illustrated) and a boiler tank 104. To address the behavior of a mixture of liquid and gas phases in low-gravity, the boiler tank 104 includes a capillary pumping surface 106 on its inside surface. The capillary pumping surface 106 may comprise a rewetting texture that can improve boiler efficiency over smooth wall surface textures in low-gravity, where surface tension forces can dominate tank fluid dynamics. Passive capillary pumping is enabled by any of a number of surface textures or features, as explained below.

Boiler system 100 is configured so that waste heat is provided from outside the boiler tank 104 to capillary pumping surface 106. The waste heat may be produced by one or more heat sources 108 in various locations in the space vehicle. In some implementations, heat sources 108 may also include devices or systems that intentionally produce heat (e.g., non-waste heat), as explained below. Boiler tank 104 includes an output port 110 to vent gas produced from boiling the cryogenic liquid in the boiler tank by the received waste heat (and/or intentionally-produced heat). Boiler system 100 may further include one or more accumulator tanks 112 that receive the vented gas from output port 110. The one or more accumulator tanks may provide to users the gas phase of the cryogenic liquid that was previously stored in cryogenic tank 102. For sake of illustrative clarity, various valves among tanks in boiler system 100 are not all illustrated.

FIG. 2 is a top view of an example surface texture 200 that enables passive capillary pumping, according to some embodiments. Surface texture 200 may cover at least a portion of the inside surface of a boiler tank, such as boiler tank 104. Accordingly, though the illustrated surface texture in FIG. 2 is rendered flat, it is likely curved to comply with the curved interior surface of a spherical or cylindrical boiler tank. As mentioned above, a capillary pumping surface addresses the behavior exhibited by a mixture of liquid and gas phases in low-gravity (e.g., micro-gravity or less). In low-gravity applications, the capillary pumping surface, such as 106, may comprise surface texture 200 as a rewetting texture that can improve boiler efficiency as compared to smooth wall surface textures. As mentioned above, in the absence of gravity or acceleration of the tank, surface tension forces generally dominate fluid dynamics in a tank containing a mixture of liquid and gas phases. For example, surface texture 200 of the capillary pumping surface tends to repel the gas phase of a fluid, which are bubbles, while attracting the liquid phase. Waste heat may then be provided to the capillary pumping surface 106 and is thus in turn provided to the liquid phase so that the liquid phase may be heated and converted to the gas phase. A relatively inefficient process would be providing heat to the gas phase of the fluid in the boiler tank, which would merely increase the localized temperature of the gas phase while not contributing to transitioning the fluid from the liquid to the gas phase (which is a core function of the boiler tank).

Surface texture 200 may include an array of unit cells 202 each comprising horizontal and vertical micro-grooves 204 separated by partitions or fins 206. For example, the micro-grooves may have a width of about 1 millimeter (mm) and length (e.g., unit cell length) of about 11 mm. This is just one example of many possible configurations. For instance, features, such as micro-grooves 204, may be any combination of shapes (e.g., linear, chevron-shaped, curved, etc.), depths, and widths. Moreover, a surface texture for passive capillary pumping need not include unit cells nor micro-grooves. A surface texture may include pores, cavities, fins, rectangular or pyramidal protrusions, and various stalagmitic structures, just to list a few examples, all of which may vary in shape and size across the inside surface of a boiler tank. Claimed subject matter is not limited to any particular shape, size, or pattern of surface texture for passive capillary pumping. Surface texture 200, whatever shape or features it may have in a particular implementation, may readily rewet after a contacting liquid is boiled away from the surface texture. Surface texture 200 may also comprise a relatively large amount of surface area for relatively efficient transfer of heat from the surface texture to the contacting liquid.

FIG. 3 is a cross-section view of a portion 302 of a boiler tank and a surface texture 304 for passive capillary pumping, according to some embodiments. For example, the boiler tank may be the same as or similar to boiler tank 104 and surface texture 304 may be the same as or similar to 200. Surface texture 304 may cover a portion 302 of the boiler tank's inside surface 306, which may be concave-spherical or concave-cylindrical. In this embodiment, surface texture 304 comprises micro-grooves 308. For example, the micro-grooves may be channels, slots, crevices, notches, fissures, recesses, pores, and/or troughs, just to name a few examples, and may be fabricated by additive manufacturing, etching, or other processes. As illustrated for this example embodiment, micro-grooves are separated by fins or partitions 310.

In the absence of gravity, an interaction between sides 312 of micro-grooves 308 and a liquid may give rise to surface tension forces leading to a capillary effect wherein wicking causes the liquid to flow in relatively narrow spaces, such as micro-grooves 308. For example, arrow 314 indicates a general motion of liquid wicking into the micro-grooves. This motion of the liquid may displace gas 316, which may be in the form of bubbles, the motion of which is indicated by arrow 318. In other words, surface tension forces pull liquid into the micro-grooves while driving out gas from the micro-grooves. This is the general process of passive capillary pumping by surface texture 304.

As mentioned above, waste heat may be provided more efficiently to a liquid in a capillary pumping surface as compared to a liquid in a smooth-walled boiler tank. For example, in low-gravity, liquid may not rest against the inside surface of a boiler tank having smooth walls. Instead, in a complicated mixture of liquid and gas phases in low gravity, gas may reside against the smooth walls. The process of a boiler (e.g., boiler tank 104) is to convert liquid into gas by the injection (or infusion) of heat (e.g., waste heat). Accordingly, it is preferred that the heat is applied to the liquid rather than the gas in a boiler tank. In contrast to the smooth wall case, surface texture 304 allows for heat, such as from heat sources 108, for example, as it transmits through the wall of the boiler tank, to reach liquid rather than gas. For example, waste heat 320 may directly “encounter” gas 316, leading to a relatively inefficient process for converting liquid into gas, since this heat transfer to gas 316 merely heats the gas and no gas-to-liquid conversion occurs during this interaction. (The relatively hotter gas will eventually lead to a gas-to-liquid conversion in the boiler tank by contributing to an overall temperature rise in the boiler tank, but this may be a relatively inefficient conversion process). On the other hand, waste heat 322 (or intentionally-produced heat) may directly “encounter” liquid that has been pulled into micro-grooves 308 by passive capillary pumping by surface texture 304, leading to a relatively efficient process for converting liquid into gas, since this heat transfer to the liquid may directly contribute to the gas-to-liquid conversion.

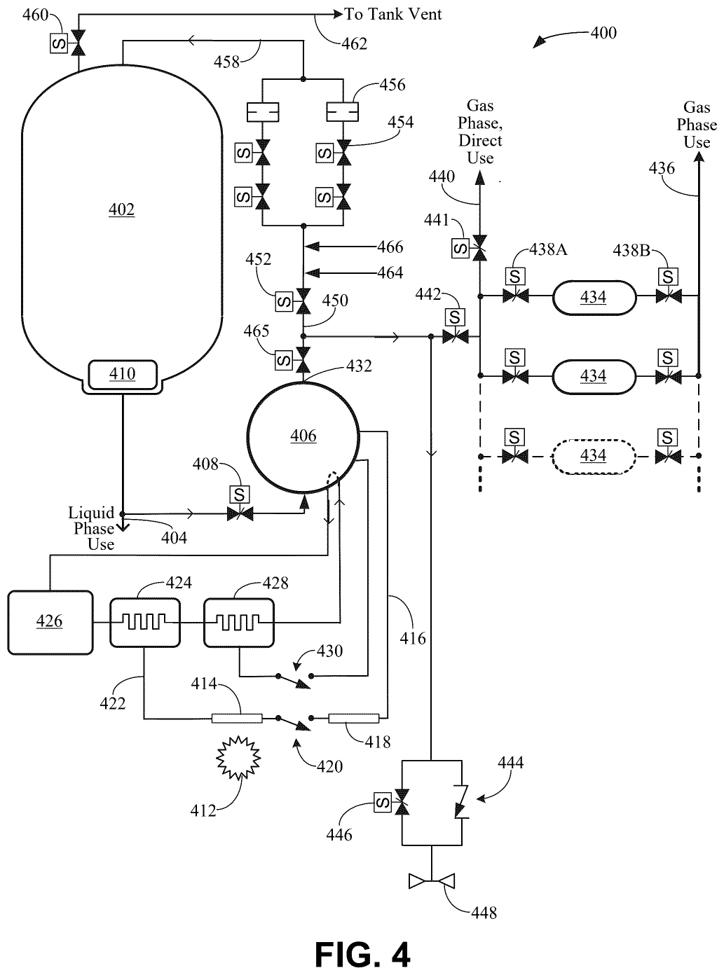

FIG. 4 is a schematic view of a boiler system 400, according to some embodiments. Boiler system 400 may be considered passive because the system utilizes waste heat to produce gas from a liquid and need not rely on heat that is specifically or intentionally generated for such gas production. Boiler system 400, which may operate in a space vehicle in micro-gravity, includes a cryogenic tank 402 that stores a cryogenic liquid, such as LO2 or LH2. For operation using LO2, magnets may be used to take advantage of the paramagnetic properties of LO2, as described below. Cryogenic tank 402 may provide its stored cryogenic liquid to any number of destinations 404 that use cryogenic liquid, such as a propulsion system that combusts a fuel-oxidizer mixture. Other uses of cryogenic liquid may include orbital maneuvering system engines, DC-power generation, and hydraulic operations, among other things. Cryogenic tank 402 may also provide its stored cryogenic liquid to a boiler tank 406 via a flow control valve 408.

Generally, storage and utilization of cryogenic liquids in micro-gravity present a problem that involves an ability to acquire only the liquid phase of the cryogenic liquid from a tank upon demand for use by the space vehicle. On Earth, where gravity is significant, liquid is generally in a known location within the tank, specifically, settled against the tank's bottom with the gas phase thereabove. In a reduced-gravity environment, however, the absence of a significant gravitational force leads to liquid and gas phases that are generally free to move about inside the tank. In other words, the liquid phase may be “floating” about the tank distant from liquid acquisition output ports (which may be at the “bottom” of the tank). Thus, fluid movement under reduced-gravity conditions generally hinders acquisition and withdrawal of liquids from a tank. Accordingly, cryogenic tank 402 may include a liquid acquisition device 410 to, among other things, efficiently supply the liquid phase of the tank's contents to various systems of the space vehicle, such as boiler tank 406.

Waste heat, which may be produced by one or more heat sources 412 in various locations in the space vehicle, may be collected by a heat collector 414, which may also be located in various locations in the space vehicle, relatively close to its corresponding heat source, for example. Such a heat source may be from a propulsion system (e.g., rocket engines), avionics, fuel cells, hydraulics, and electrical power systems, just to name a few examples. For instance, if the heat source is a rocket engine, heat collector 414 may be a heat exchanger in thermal contact with the combustion region of the rocket engine. In some implementations, heat collector 414 may be a heat exchanger that includes a circulating fluid to carry heat from its source to a heat transfer path 416 that ultimately leads to boiler tank 406. In some implementations, a portion of heat transfer path 416, which may be a circulating fluid or a heat conducting conduit or route, may function as a heat collector 414. In some implementations, an additional heat collector 418 may collect waste heat from the same source as heat collector 414. By having two (or more) heat collectors, and a thermal flow valve 420 therebetween, the amount of waste heat collected from the heat source may be controlled and varied as desired. Herein, a thermal flow valve, or a thermal switch, controls thermal energy flow in a heat transfer path. In other implementations, additional heat collector 418 may collect waste heat from one or more sources other than that of heat collector 414. Again, using thermal flow valve 420 therebetween, the amount of waste heat collected from the various heat sources and provided to boiler tank 406 may be controlled as desired. In some implementations, heat collector 414 may be in thermal contact 422 with a heat exchanger 424 of a thermal control system 426, which is described below. Via this thermal contact, heat collector 414 may collect waste heat from heat exchanger 424 or provide waste heat to the heat exchanger.

Thermal control system 426 may be used to add heat to boiler tank 406 by selectively circulating (e.g., via a pump) a heat-carrying fluid, such as ammonia (NH3), through a portion of the boiler tank, as described below. The heat-carrying fluid may circulate through heat exchanger 424 and an additional heat exchanger 428. These heat exchangers may operate to heat the heat-carrying fluid, depending on the operating conditions (e.g., temperature of the contents) of boiler tank 406. For example, heat collector 414 may provide waste heat to heat exchanger 424, which will act to heat the heat-carrying fluid in thermal control system 426. Heat exchanger 428, while cooling the heat-carrying fluid, may provide waste heat, via a thermal flow valve 430, to boiler tank 406.

In summary, the above-described elements of boiler system 400, namely heat collectors 414 and 418, thermal flow valves 420 and 430, and heat exchangers 424 and 428, allow for a number of processes to control heat transfer into boiler tank 406. Various combinations of using these elements may allow for controlling the amount (e.g., a transfer rate) of waste heat transfer from a number of sources on the space vehicle.

Boiler tank 406 includes an output flow port 432 to vent gas produced from boiling cryogenic liquid in the boiler tank by the received waste heat. Boiler system 400 may further include one or more accumulator tanks 434 that receive the vented gas from output flow port 432. Thus, on demand, the one or more accumulator tanks may provide, via line 436, the gas phase of the cryogenic liquid that was previously stored in cryogenic tank 402 to one or more systems in the space vehicle. In some implementations, a series of accumulator tanks 434 may be filled sequentially as boiler tank 406 continues to produce vented gas. In other implementations, two or more accumulator tanks 434 may be filled in parallel with vented gas.

Boiler system 400 may further include flow control valves 438A and 438B to respectively control flow on the input and output sides of the accumulator tanks. Such valves may be any of a number of types of valves such as check valves, solenoid valves, and pneumatically operated valves, just to name a few examples. In some implementations, a user or a system of the space vehicle may receive the gas phase directly from boiler tank 406 via a line 440 and flow control valves 441 and 442. This portion of boiler system 400 may include a vent relief valve 444, which may be shunted with a flow control valve 446, and a vent 448, which may vent gas to outside the space vehicle, for example.

Boiler system 400 may further include a secondary gas pressurant supply route 450 that can supply pressurized gas from boiler tank 406 to cryogenic tank 402. The secondary gas pressurant supply route 450, which may be gated by a main flow control valve 452, may include pressurization control valves 454 and one or more pressure control valves (orifices) 456 to limit pressurization flow to tank 402. The secondary gas pressurant supply route may subsequently provide a controlled pressurized gas to cryogenic tank 402 via line 458. Pressure in cryogenic tank 402 may be further controlled by operating a vent valve 460 that leads to a vent 462, which may vent gas to outside the space vehicle, for example. In some implementations, secondary gas pressurant supply route 450 may receive a pressurized gas (the same type of gas produced in boiler tank 406) from a primary gas pressurant supply 464, such as from engines of the space vehicle, for example. In further implementations, secondary gas pressurant supply route 450 may receive a pressurized gas from accumulator tanks 434. In such implementations, a valve 465 may first be closed to prevent the pressurized gas from entering boiler tank 406. In still further implementations, secondary gas pressurant supply route 450 may receive pressurized helium gas (GHe) from a GHe pressurant supply 466, which may be used for purging at least portions of boiler system 400, for example.

In some embodiments, a process of operating boiler system 400 for hydrogen or oxygen includes a number of steps. For example, as a first step, an operator may evacuate boiler tank 406 to space through vent 448 and then close vent relief valve 444. As a second step, the operator may trickle flow LH2 or LO2 into the boiler tank to chill down the boiler tank and associated plumbing. As a third step, the operator may vent the chill-down fluid to space. The second and third steps may be repeated as needed to bring the boiler tank wall temperature down to less than 40 R for LH2 and less than 165 R for LO2, for example. (Absolute temperature in English units is recited here, in degrees Rankine: deg. R=deg. F+459.67) As a fourth step, the operator may, during a last chill-down cycle, close vent relief valve 444 with a few (e.g., 1 or 2) psia (pounds per square inch relative to vacuum) remaining in the boiler tank for LH2 and a few psia remaining in the boiler tank for LO2, for example.

As a fifth step, for LO2 in some implementations, the operator may start magnetic enhancer superconduction, which is described below. As a sixth step, the operator may transfer the cryogenic liquid under tank head pressure to the boiler tank, filling it to about 30% for LH2 and to about 25% for LO2, and then close flow control valve 408. Note that such recited percentages are merely particular examples and claimed subject matter is not limited in this respect. As a seventh step, the operator may add space vehicle waste heat (e.g., from any system that produces such waste heat) to boiler tank 406 from a pumped thermal control loop of thermal control system 426 and/or heat transfer path(s) 416 (e.g., heat pipes or other heat-carrying conduit or path). As an eight step, the operator may allow heat to flow (e.g., using heat collectors 414 and 418, thermal flow valves 420 and 430, and/or heat exchangers 424 and 428) into the boiler tank until pressure in the boiler tank reaches 5000 psia, though claimed subject matter is not limited to this example pressure value. As a ninth step, in the case for oxygen, the operator may stop the magnetic enhancer superconduction. As a tenth step, the operator may open boiler-accumulator valves (e.g., 442 and 438A) to vent GH2 or GO2 from boiler tank 406 into accumulators 434. As an eleventh step, the operator may, after pressure is equalized between the accumulators and the boiler tank, close the boiler-accumulator valves. As a twelfth step, the operator may, via thermal control system 426, stop or reroute the circulating flow of heat-carrying fluid, such as NH3, through a portion of the boiler tank. As a thirteenth step, the operator may open thermal flow valves 420 and/or 430 to stop thermal flow from heat collector 414 and/or heat exchangers 428, for example. As a fourteenth step, the operator may repeat the previous steps until accumulators are recharged to 3000 psia, though claimed subject matter is not limited to this example pressure value. As a fifteenth step, the operator may augment pressurization in the boiler tank using the remaining GH2 or GO2 or vent the remaining GH2 or GO2 to space.

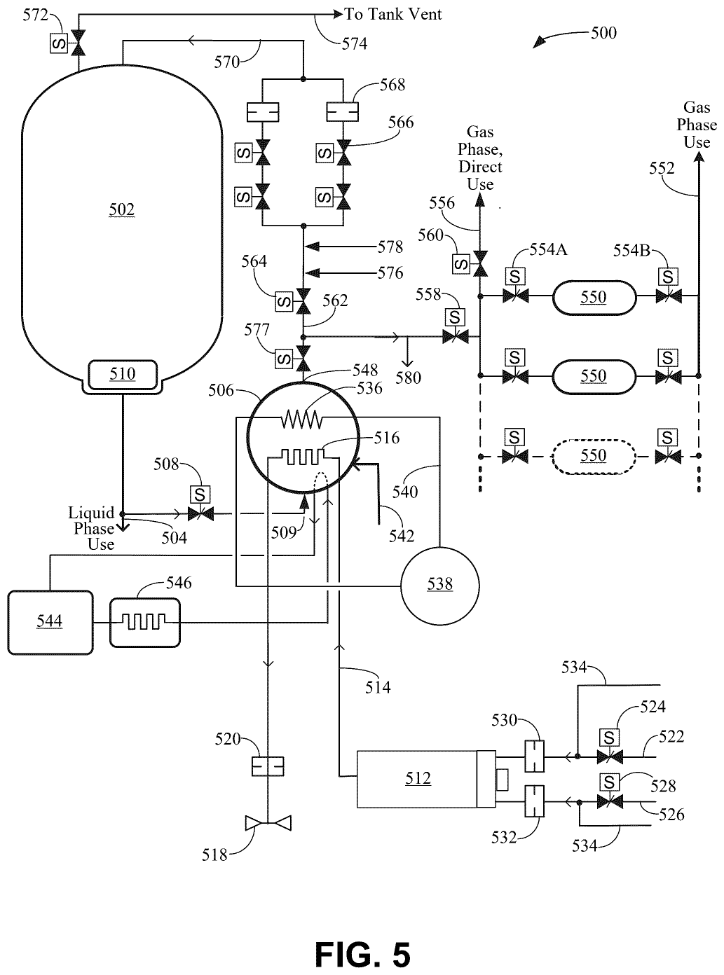

FIG. 5 is a schematic view of a boiler system 500, according to some embodiments. Boiler system 500 may operate as a passive system, similar to or the same as how boiler system 400 may be operated (e.g., using waste heat). Boiler system 500, however, includes features that allow it to be operated non-passively, wherein heat is specifically generated for its operation of producing gas from a cryogenic liquid. Boiler system 500 may also include waste heat collectors and paths to utilize waste heat. By controlling various valves in the system, for example, any of the multiple heat sources, whether waste heat, intentionally-produced heat, or both, may be selected based on mission parameters or operation of a space vehicle. For example, a selection of a heat source may be based on the time scale of operation. Generally, intentionally-produced heat may be available, and in a higher quantity, in a relatively short time as compared to the time of availability of waste heat. Accordingly, if a mission or operation of a space vehicle requires production of gas in a short time span, then boiler system 500 may use intentionally-produced heat instead of, or in addition to, waste heat. On the other hand, if a mission or operation of a space vehicle is a long-term endeavor that only requires production of gas over a long period of time, then boiler system 500 may avoid using intentionally-produced heat (to conserve resources) and instead use only waste heat. In another example, operation(s) of a space vehicle may produce excess waste heat that may best be expended by heat absorption during a process of producing gas from liquid in a boiler tank. In this case, there may not be a need to intentionally produce heat by consuming fuel or electricity stored in batteries, for example.

Boiler system 500, which may operate in a space vehicle in micro-gravity, includes a cryogenic tank 502 that stores a cryogenic liquid, such as LO2 or LH2. For operation using LO2, magnets may be used to take advantage of the paramagnetic properties of LO2. Cryogenic tank 502 may provide its stored cryogenic liquid to any number of destinations 504 that use cryogenic liquid, such as a propulsion system that combusts a fuel-oxidizer mixture. Other uses of cryogenic liquid may include orbital maneuvering system engines, DC-power generation, and hydraulic operations, among other things. Cryogenic tank 502 may also provide its stored cryogenic liquid to a boiler tank 506 via a flow control valve 508 and fill port 509.

For acquisition and withdrawal of liquids under reduced-gravity conditions, cryogenic tank 502 may include a liquid acquisition device 510 to, among other things, efficiently supply the liquid phase of the tank's contents to various systems of the space vehicle, such as boiler tank 506.

In contrast to boiler system 400, boiler system 500 may use heat that is generated specifically to heat the contents in the boiler tank of the system. Such heat may be generated by various sources. For example, heat generated by a combustion device 512 may be provided to boiler tank 506 via a heat conduction path 514, which may be a conduit that carries relatively hot exhaust produced by the combustion device. Via the conduit, for heating the contents of boiler tank 506, the exhaust may flow through a heat exchanger 516 inside the boiler tank. In some implementations, heat exchanger 516, or a portion thereof, may be in the wall of the boiler tank. After passing through the heat exchanger, the exhaust may be released out a vent 518 that leads to after passing through a pressurization control valve 520 In some implementations, this heat recovery may produce waste heat that may be fed back to boiler tank 506. In some embodiments, heat exchanger 516 may be at least partially covered with a surface texture, similar to or the same as surface texture 304, for example.

In some embodiments, combustion device 512 may combust a vaporized mixture of a fuel and an oxidizer. For example, the combustion device may receive GH2 from a source 522 via a flow control valve 524. The combustion device may also receive GO2 from a source 526 via a flow control valve 528. Each gas may pass through a pressurization control valve 530 and 532, respectively. In some implementations, helium gas (GHe) may be selectively provided, via supply lines 534, for purging this portion of boiler system 500.

In some embodiments, boiler tank 506 may include an electric resistance element 536 (e.g., a resistance coil heater) to provide heat to the contents in the boiler tank. In some implementations, electric resistance element 536, or a portion thereof, may be in the wall of the boiler tank and/or inside the boiler tank, in direct contact with the contents therein. In some implementations, electric resistance element 536 may be at least partially covered with a surface texture, similar to or the same as surface texture 304, for example. An electric generator 538 may provide electric current to the electric resistance element 536 along an electric conduction path 540 that penetrates the wall of the boiler tank.

In addition to the sources of intentionally-generated heat (e.g., heat exchanger 516 and electric resistance element 536 are among a number of possibilities), boiler system 500 may also include one or more passive heat sources, such as those described for boiler system 400. For example, passive waste heat may arise from operations of a propulsion system (e.g., rocket engines), avionics, fuel cells, hydraulics, and electrical power systems, just to name a few examples. Heat from these passive heat sources may be provided, as indicated by arrow 542, to boiler tank 506.

Boiler system 500 may include a thermal control system 544 to control the temperature in boiler tank 506 by selectively circulating (e.g., via a pump) a heat-carrying fluid, such as NH3, through a portion of the boiler tank. The heat-carrying fluid may circulate through heat exchanger 546 that may operate to heat or cool the heat-carrying fluid, depending on the operating conditions (e.g., temperature of the contents) of boiler tank 506.

Boiler tank 506 includes an output port 548 to vent gas produced from boiling cryogenic liquid in the boiler tank by the received heat (e.g., intentionally-produced heat or waste heat). In some implementations, output port 548 may be combined with fill port 509 (although with separate input and output lines), the two of which are to be operated at different times in this configuration. Boiler system 500 may further include one or more accumulator tanks 550 that receive the vented gas from output port 548. Thus, on demand, the one or more accumulator tanks may provide, via line 552, the gas phase of the cryogenic liquid that was previously stored in cryogenic tank 502 to one or more systems in the space vehicle. Boiler system 500 may further include flow control valves 554A and 554B to respectively control flow on the input and output sides of the accumulator tanks. In some implementations, a user or a system of the space vehicle may receive the gas phase directly from boiler tank 506 via a line 556 and flow control valves 558 and 560.

Boiler system 500 may further include a secondary gas pressurant supply route 562 that can supply pressurized gas from boiler tank 506 to cryogenic tank 502. The secondary gas pressurant supply route 562, which may be gated by a main flow control valve 564, may include pressurization control valves 566 and one or more pressurization control valves 568. The secondary gas pressurant supply route may subsequently provide a controlled pressurized gas to cryogenic tank 502 via line 570. Pressure in cryogenic tank 502 may be further controlled by operating a pressurization control valve 572 that leads to a vent 574, which may vent gas to outside the space vehicle, for example. In some implementations, secondary gas pressurant supply route 562 may receive a pressurized gas (the same type of gas produced in boiler tank 506) from a primary gas pressurant supply 576, such as from engines of the space vehicle, for example. In further implementations, secondary gas pressurant supply route 562 may receive a pressurized gas from accumulator tanks 550. In such implementations, a valve 577 may first be closed to prevent the pressurized gas from entering boiler tank 506. In still further implementations, secondary gas pressurant supply route 562 may receive pressurized helium gas from a GHe pressurant supply 578, which may be used for purging at least portions of boiler system 500, for example.

In some embodiments, a process of operating boiler system 500 for hydrogen or oxygen includes a number of steps. For example, as a first step, an operator may evacuate boiler tank 506 to space through a vent 580 (which may be valved) and subsequently close the vent. As a second step, the operator may trickle flow LH2 or LO2 into the boiler tank to chill down the boiler tank and associated plumbing. As a third step, the operator may vent the chilldown fluid to space. The first and second steps may be repeated as needed to bring the boiler tank wall temperature down to less than 50K for LH2 and less than 165K for LO2, for example. As a fourth step, the operator may, during a last chill-down cycle, close vent 580 with about 2 psia remaining in the boiler tank for LH2 and about 1 psia remaining in the boiler tank for LO2, just to give a particular numerical example for which claimed subject matter is not so limited.

As a fifth step, for LO2 in some implementations, the operator may start magnetic enhancer superconduction. As a sixth step, the operator may transfer the cryogenic liquid under tank pressure delta to the boiler tank, filling it to about 30% for LH2 and to about 25% for LO2, and then close flow control valve 508. As a seventh step, the operator may add heat from any combustion devices (e.g., 512) or electrical elements (e.g., 536) to boiler tank 506. In some implementations, the operator may also add space vehicle waste heat (e.g., from any system that produces such waste heat) to boiler tank 506 from a pumped thermal control loop of thermal control system 544 and/or heat transfer path(s) from passive heat sources (indicated by arrow 542).

As an eight step, the operator may allow passive heat to flow into the boiler tank until pressure in the boiler tank reaches 5000 psia, though claimed subject matter is not limited to this example pressure value. As a ninth step, in the case for oxygen, the operator may stop the magnetic enhancer superconduction. As a tenth step, the operator may open boiler-accumulator valves (e.g., 558 and 554A) to vent GH2 or GO2 from boiler tank 506 into accumulators 550. As an eleventh step, the operator may, after pressure is equalized between the accumulators and the boiler tank, close the boiler-accumulator valves. As a twelfth step, the operator may, via thermal control system 544, stop or reroute the circulating flow of heat-carrying fluid, such as NH3, through a portion of the boiler tank. The operator may also turn off any combustion devices that have been directly providing heat to the boiler tank. As a thirteenth step, the operator may purge these combustion devices after use with GHe to avoid freezing of residual exhaust or reactants. In some implementations, the operator may instead (or in addition) vent the combustion devices, so as to avoid the use and “waste” of helium. As a fourteenth step, the operator may repeat the previous steps until accumulators are recharged to 3000 psia, though claimed subject matter is not limited to this example pressure value. As a fifteenth step, the operator may augment pressurization in the boiler tank using the remaining GH2 or GO2 or vent the remaining GH2 or GO2 to space.

In some implementations, freezing of H2 or O2 in the boiler tank may be a concern. Accordingly, a stepped boiler heat transfer process may be used. Thus, for example, a sequential, staggered approach may be performed to heat the boiler tank and its contents. In a particular example, thermally conductive straps or other heat conducting paths may first be used to increase the temperature of the boiler tank from cryogenic temperatures up to a temperature where ammonia, such as the ammonia in thermal control system 544, will not freeze. Then the ammonia may be used to transfer heat into the boiler tank. An operation of heating the boiler tank and its contents may include switching to still another heat transfer method like water or exhaust from combustion device 512, for example.

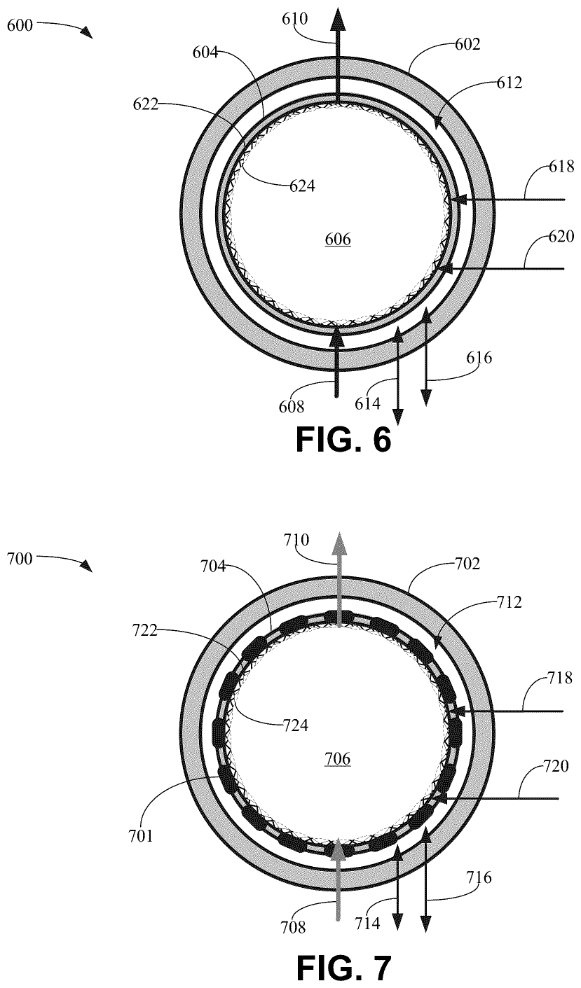

FIG. 6 is an open side view of a boiler tank 600, according to some embodiments. For example, boiler tank 600 may be similar to, or the same as any of boiler tanks 104, 406, and 506. Boiler tank 600 comprises an exterior wall 602 and an interior wall 604. The inside 606 of the boiler tank may be configured to hold a cryogenic fluid comprising a gas phase, a liquid phase, or a mixture of both these phases. The cryogenic fluid may enter the boiler tank (substantially as a liquid) via an input flow port 608 and exit the boiler tank (substantially as a gas) via an output flow port 610. In some implementations, output flow port 610 may be combined with input flow port 608 (although with separate input and output lines), the two of which are to be operated at different times in this configuration. A channel 612, which may be a single channel or multiple individual channels (e.g., tubes), may be within portions of exterior wall 602 and interior wall 604 or therebetween. Channel 612 may accommodate flow of a heat-carrying fluid, such as NH3, through a portion of the boiler tank. A thermal control system, such as 426, may circulate the heat-carrying fluid through channel 612 to control the temperature of inside 606 of the boiler tank. Ingress and egress of the heat-carrying fluid into and out of channel 608 is indicated by arrows 614 and 616. Waste heat may be provided to contents of the boiler tank via a thermally conductive path or a conduit that carries a heated fluid, from outside exterior wall 602 and through interior wall 604, as indicated by arrow 618. Though not illustrated in FIG. 6, the thermally conductive path or conduit may avoid channel 612 by following a route that extends across the channel, effectively bridging the channel between exterior wall 602 and interior wall 604.

Heat intentionally produced for heating boiler tank 600 may be provided to contents of the boiler tank by a number of methods. For example, the heat may be provided via a thermally conductive path or a conduit that carries a heated fluid, from outside exterior wall 602 and through interior wall 604, as indicated by arrow 620. In another method, heat may be provided by a conduit (e.g., 514) that carries a heated exhaust from a combustion device (e.g., 512) through a heat exchanger (e.g., 516), as described above, for example. In still another method, heat may be provided by an electric resistance element (e.g., 536) connected to electrical conductors (e.g., wires) that pass through, and are electrically insulated from, outside exterior wall 602 and interior wall 604, for example. Though not illustrated in FIG. 6, the thermally conductive path or conduit may avoid channel 612 by following a route that extends across the channel, effectively bridging the channel between exterior wall 602 and interior wall 604. The electrical conductors may also follow such a route or may pass through channel 612.

The inside surface 622 of interior wall 604 may include a surface texture 624, which may be the same as or similar to surface texture 200 described above. Surface texture 624 may enable passive capillary pumping, according to some embodiments. Surface texture 624 may cover at least a portion of inside surface 622. As explained above, a capillary pumping surface addresses the behavior exhibited by a mixture of liquid and gas phases in low-gravity (e.g., micro-gravity or less), which is what is likely to be in boiler tank 600 during a liquid-to-gas conversion (e.g., boiling) process.

FIG. 7 is an open side view of a boiler tank 700 for use with oxygen or other cryogenic paramagnetic fluids, according to some embodiments. For example, boiler tank 700 may be similar to or the same as boiler tank 600 except for the addition of magnets 701, as described below. Boiler tank 700 comprises an exterior wall 702 and an interior wall 704. The inside 706 of the boiler tank may be configured to hold cryogenic oxygen comprising a gas phase, a liquid phase, or a mixture of both these phases. The cryogenic oxygen may enter the boiler tank (substantially as a liquid) via an input flow port 708 and exit the boiler tank (substantially as a gas) via an output flow port 710. A channel 712 may be within portions of exterior wall 702 and interior wall 704 or therebetween. Channel 712 may accommodate flow of a heat-carrying fluid, such as NH3, through a portion of the boiler tank. A thermal control system, such as 426, may circulate the heat-carrying fluid through channel 712 to control the temperature of inside 706 of the boiler tank. Ingress and egress of the heat-carrying fluid into and out of channel 708 is indicated by arrows 714 and 716. Waste heat may be provided to contents of the boiler tank via a thermally conductive path or a conduit that carries a heated fluid, from outside exterior wall 702 and through interior wall 704, as indicated by arrow 718. Though not illustrated in FIG. 7, the thermally conductive path or conduit may avoid channel 712 by following a route that extends across the channel, effectively bridging the channel between exterior wall 702 and interior wall 704.

Heat intentionally produced for heating boiler tank 700 may be provided to contents of the boiler tank by a number of methods. For example, the heat may be provided via a thermally conductive path or a conduit that carries a heated fluid, from outside exterior wall 702 and through interior wall 704, as indicated by arrow 720. In another method, heat may be provided by a conduit (e.g., 514) that carries a heated exhaust from a combustion device (e.g., 512) through a heat exchanger (e.g., 516), as described above, for example. In still another method, heat may be provided by an electric resistance element (e.g., 536) connected to electrical conductors (e.g., wires) that pass through, and are electrically insulated from, outside exterior wall 702 and interior wall 704, for example. Though not illustrated in FIG. 7, the thermally conductive path or conduit may avoid channel 712 by following a route that extends across the channel, effectively bridging the channel between exterior wall 702 and interior wall 704. The electrical conductors may also follow such a route or may pass through channel 712.

The inside surface 722 of interior wall 704 may include a surface texture 724, which may be the same as or similar to surface texture 200 described above. Surface texture 724 may enable passive capillary pumping, according to some embodiments. Surface texture 724 may cover at least a portion of inside surface 722. In addition to the capillary pumping provided by surface texture 724, magnets 701 may be placed in or about interior wall 704 so that a magnetic field reaches inside surface 722. Like surface texture 724 and its resulting passive capillary pumping, the magnets may also address the behavior exhibited by a mixture of liquid and gas phases in low-gravity (e.g., micro-gravity or less), which is what is likely to be in boiler tank 700 during a liquid-to-gas conversion (e.g., boiling) process.

Though sixteen magnets are schematically illustrated, magnets 701 may comprise any number of magnets, which may be permanent magnets or electromagnets. In some implementations, each of magnets 701 may be an electromagnet comprising one or more superconductive coils. In such implementations, magnets 701 may be substantially near inside 706 so that cryogenic oxygen may cool the superconductive coils.

Magnets 701 may be configured to apply a magnetic field to the two-phase oxygen in a region relatively near inside surface 722. For example, the strength of the magnetic field in a region nearest the inside surface is substantially stronger than regions further from the inside surface. Such a region nearest the inside surface may be considered to be at least partially surrounding micro-features of surface texture 724 and extending a dozen or so centimeters from inside surface 722, though claimed subject matter is not so limited. This region may include a magnetic field that is strong enough to affect motions of two-phase oxygen. In contrast, other portions of inside 706 may include two-phase oxygen that is not subjected to a magnetic field strong enough to substantially affect its motion.

The strength of the paramagnetic effect of oxygen is temperature dependent and phase dependent. Thus, for a given temperature, the paramagnetic effect is greater for liquid oxygen than for gaseous oxygen. These dependencies may allow a magnetic field to create local convection currents near inside surface 722, because the magnetic field preferentially attracts, among the fluid, colder liquid oxygen over both warmer liquid oxygen and gaseous oxygen. The displacement of gaseous oxygen by liquid oxygen may cause the gaseous oxygen to coalesce into bubbles and be expelled, similar to bubbles of gas 316 illustrated in FIG. 3. Convection currents, and the preferential attraction of liquid over gas, may enhance heat transfer from heat (e.g., waste heat) provided from outside boiler tank 700 to near inside surface 722 and may induce greater bulk mixing of the fluid in the boiler tank.

The relatively strong paramagnetic attraction of liquid oxygen by the magnetic field may also beneficially interfere with oxygen vapor adhesion to inside surface 722 during nucleate boiling. The magnetic field may induce early coalescence of the oxygen into a bubble, and expulsion from inside surface 722. Convection currents may arise from the flow of bubbles (e.g., 316) away from inside surface 722. The magnetic field tends to pull in liquid, resulting in expulsion of gas bubbles, thus creating a current. A substantially bubble-free region may be created by the continuous influx of liquid oxygen flowing toward the magnet, effectively displacing the bubbles away from the magnet (e.g., the liquid tending to reach the magnet pushes bubbles out of the way). As mentioned above, these currents may enhance heat transfer from inside surface 722 to the oxygen. In regions nearest inside surface 722, bubbles may be almost entirely excluded as a result of vapor created from boiling at or near inside surface 722 being ejected by the magnetic field from these regions.

In some embodiments, boiler tank 700 may not include a surface texture for passive capillary pumping and instead may rely on above-described magnetic fields to allow for repulsion of gas and attraction of liquid to inside surface 722. In some embodiments, such magnetic fields may be applied to a region surrounding a heat exchanger, such as 516, and/or an electric resistance element, such as 536, to allow for repulsion of gas and attraction of liquid to their surfaces.

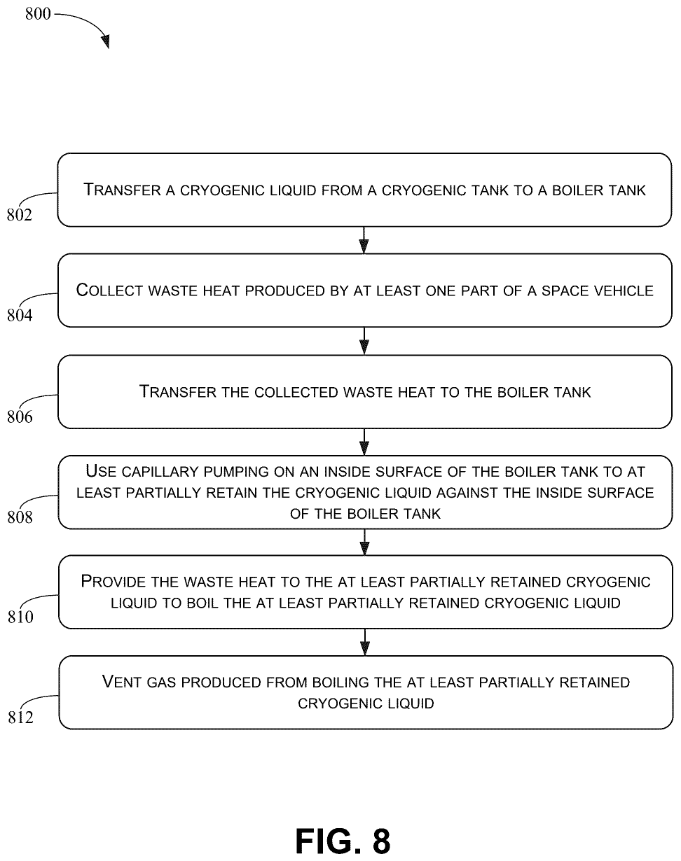

FIG. 8 is a flow diagram of an example process 800 for operating a passive boiler system, such as 400, in a low-gravity environment, according to some embodiments. For example, the process may be performed by an operator such as a crew member, an electronic controller, a computer processing system following computer-executable instructions, or a combination thereof.

At 802, the operator may transfer a cryogenic liquid from a cryogenic tank 402 to a boiler tank 406. At 804, the operator may collect waste heat produced by at least one part of a space vehicle. For example, waste heat may be collected by heat collectors 414 and 418. At 806, the operator may transfer the collected waste heat to the boiler tank. At 808, the operator may use capillary pumping on an inside surface of the boiler tank to at least partially retain the cryogenic liquid against the inside surface of the boiler tank. At 810, the operator may provide the waste heat to the at least partially retained cryogenic liquid to boil the at least partially retained cryogenic liquid. At 812, the operator may vent gas produced from boiling the at least partially retained cryogenic liquid. The vented gas may then be collected in one or more accumulator tanks. In some implementations, the cryogenic liquid is liquid oxygen and a magnetic field may be applied to the inside surface of the boiler tank. In some implementations, exhaust from a combustion device may be used to transfer heat to the cryogenic liquid in the boiler tank. In some implementations, a pumped fluid may be circulated in a thermal control loop to exchange heat with the at least partially retained cryogenic liquid. In some implementations, the operator may operate a thermal switch that controls a transfer rate of the collected waste heat to the boiler tank.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A passive boiler system for operating in a low-gravity environment, the system comprising:
a boiler tank to receive a cryogenic liquid;
a capillary pumping surface on an inside surface of the boiler tank, the capillary pumping surface configured to receive heat from outside the boiler tank; and
an output port on the boiler tank to vent gas produced from boiling the cryogenic liquid in the boiler tank by the received heat.

2. The system of claim 1, further comprising an accumulator tank configured to receive the vented gas from the output port.

3. The system of claim 1, wherein the heat is waste heat produced by at least one part of a space vehicle, the system further comprising:
a heat collector to collect the waste heat; and
a heat transfer path from the heat collector to the capillary pumping surface in the boiler tank.

4. The system of claim 3, wherein the heat transfer path includes a conduit to carry heated fluid.

5. The system of claim 3, wherein the heat transfer path includes a solid heat conductive material that penetrates at least a portion of the boiler tank.

6. The system of claim 3, wherein the heat collector is configured to collect waste heat produced by a hydraulic system of the space vehicle.

7. The system of claim 3, wherein the heat collector is configured to collect waste heat produced by fuel cells of the space vehicle.

8. The system of claim 3, wherein the heat collector is configured to collect waste heat produced by a fuel/oxidizer propulsion system of the space vehicle.

9. The system of claim 1, wherein the cryogenic liquid is liquid oxygen, and wherein the boiler tank includes magnets adjacent to the capillary pumping surface.

10. The system of claim 1, wherein the boiler tank includes a portion of a thermal control loop external to the capillary pumping surface, the thermal control loop configured to carry pumped fluid.

11. The system of claim 1, further comprising a thermal switch that controls thermal energy flow in the heat transfer path.

12. The system of claim 1, further comprising a heat exchanger in the boiler tank, the heat exchanger configured to receive exhaust from a combustion device.

13. The system of claim 1, further comprising a resistance coil heater in the boiler tank, the resistance coil heater electrically connected to an electric current source.

14. The system of claim 1, wherein the accumulator tank is inside the boiler tank.

15. A method of operating a passive boiler system in a low-gravity environment, the method comprising:
transferring a cryogenic liquid from a cryogenic tank to a boiler tank;
collecting waste heat produced by at least one part of a space vehicle;
transferring the collected waste heat to the boiler tank;
using capillary pumping on an inside surface of the boiler tank to at least partially retain the cryogenic liquid against the inside surface of the boiler tank;
providing the waste heat to the at least partially retained cryogenic liquid to boil the at least partially retained cryogenic liquid; and
venting gas produced from boiling the at least partially retained cryogenic liquid.

16. The method of claim 15, further comprising collecting the vented gas in an accumulator tank.

17. The method of claim 15, wherein the cryogenic liquid is liquid oxygen, the method further comprising applying a magnetic field to the inside surface of the boiler tank.

18. The method of claim 15, further comprising allowing exhaust from a combustion device to transfer heat to the cryogenic liquid in the boiler tank.

19. The method of claim 15, further comprising circulating a pumped fluid in a thermal control loop to exchange heat with the at least partially retained cryogenic liquid.

20. The method of claim 15, further comprising operating a thermal switch that controls a transfer rate of the collected waste heat to the boiler tank.
